(19) United States
(12) Patent Application Publication
(10) Pub. No.: US 2025/0321318 A1
(43) Pub. Date: Oct. 16, 2025

(54) DEVICE FOR DETECTING MOVEMENT OF A PERSON BY MICROWAVES FOR A MOTOR VEHICLE

(71) Applicant: Continental Automotive Technologies GmbH, Hannover (DE)

(72) Inventors: Mohamed CHEIKH, Toulouse (FR); Amaia FORTES MONTILLA, Muret (FR); Sébastien KESSLER, Drémil - lafage (FR)

(73) Assignee: Continental Automotive Technologies GmbH, Hannover (DE)

(21) Appl. No.: 19/050,689

(22) Filed: Feb. 11, 2025

(30) Foreign Application Priority Data
Apr. 11, 2024 (FR) FR2403749

(51) Int. Cl. G01S 7/03; G01S 13/56; G01S 13/931; H01Q 1/32

(52) U.S. Cl. CPC G01S 7/032; G01S 13/56; G01S 13/931; H01Q 1/3233

(57) ABSTRACT

A device for detecting movement of a person by microwaves for a motor vehicle, the device including a radiating impedance module configured to be powered by a DC voltage supply and including a detection antenna, a MOSFET transistor and an impedance matcher forming a closed-loop electrical circuit oscillating at the predetermined fixed frequency when the circuit is powered by the voltage provided by the DC voltage supply.

### CROSS REFERENCE TO RELATED APPLICATIONS

This application claims priority to French Application No. 2403749, filed Apr. 11, 2024, the contents of such application being incorporated by reference herein.

### FIELD OF THE INVENTION

The present invention pertains to the field of motor vehicles and relates more particularly to a device and a method for detecting movement of a person by microwaves for a motor vehicle.

### BACKGROUND OF THE INVENTION

In a motor vehicle, it is known to detect the presence of a hand on a handle or of a foot close to the trunk of the vehicle in order to unlock one or more opening elements of the vehicle.

In a first type of known solutions, this presence detection, known as “near field”, is carried out using a detector generally installed in the handle or under the trunk. This detector comprises a radar-type antenna or a capacitive sensor.

When a part of the human body, such as a hand or a foot, comes within a few centimeters of the antenna, for example less than 5 cm, it modifies the impedance of the near-field antenna and an analog or digital circuit of the detector makes it possible to detect this modification, synonymous with human presence.

However, the range of this detection is limited to a few centimeters for radiofrequency antennas, in particular to less than 5 centimeters for most radiofrequency antennas. The main drawback of this technique is the very limited range for performing detection functions such as the intrusion of a person into a vehicle.

In a second type of known solutions, the presence detection is carried out using a detector implemented by a communication module installed in the vehicle and using microwaves, in particular based on BLE (Bluetooth® Low Energy) or UWB (Ultra-Wideband) technology.

In these solutions, the presence detection may be carried out in the far field, for example up to 30 meters, but require the use of at least two antennas: a transmitting antenna, which sends waves in the form of pulses, and a receiving antenna, which receives the waves reflected from one or more moving targets in the coverage area.

The detector determines that the targets are moving by using the time of flight of the signals, this requiring complex digital processing and therefore significant processing capabilities and high power consumption. Furthermore, the need for several antennas makes the solution complex and expensive and increases the risk of radio interference with the hands-free near-field access system because the number of spaces available between each pulse to receive the access frames is small. Finally, the standards in force impose limitations in terms of power, which may significantly limit the use of several antennas transmitting microwaves or cause the radio approval threshold to be exceeded in the communication band, in particular in UWB.

A simple, reliable and effective solution allowing these drawbacks to be at least partially rectified would therefore be advantageous.

### SUMMARY OF THE INVENTION

To this end, an aspect of the invention is firstly a device for detecting movement of a person by microwaves for a motor vehicle, said device comprising a radiating impedance module configured to be powered by a DC voltage supply via a switch, said radiating impedance module comprising a detection antenna configured to resonate at a predetermined fixed frequency when said detection antenna is coupled to a resonant module, to transmit microwaves and to receive microwaves reflected from said person, a MOSFET transistor and an impedance matcher forming a closed-loop electrical circuit oscillating at the predetermined fixed frequency when said circuit is powered by the voltage provided by said DC voltage supply, the detection antenna being connected to the gate of the transistor, the impedance matcher being installed between the gate and the drain of the transistor and being configured to match the impedance of the detection antenna to the impedance of the transistor while being powered by the voltage provided by said DC voltage supply, the source of the transistor being configured to be connected on the one hand to ground and on the other hand to an electronic control unit, the voltage signal delivered by the source of the transistor being representative of the impedance differences of the radiating impedance module, the impedance being stable when the frequency of the waves reflected from the person is equal to the frequency of the waves transmitted at the predetermined fixed frequency, indicating an absence of movement of the person, and different when the frequency of the waves reflected from the person differs by a frequency difference of greater than a threshold with respect to the predetermined fixed frequency, indicating the detection of a movement of the person.

An aspect of the invention proposes a detection technique based on a radiating impedance. The stability of this impedance is maintained by the impedance matcher and the MOSFET transistor. The oscillating module acts as a stable transmitter/receiver/detector at a given frequency in the absence of movement. The reception of a frequency shifted by a few Hertz by a movement in the radiation area, in the same frequency band, destabilizes its impedance. The destabilization of the impedance generates a variable leakage voltage that is easily detectable at the output. An aspect of the invention thus proposes a simple detection strategy that does not require a complex detection algorithm. The oscillating loop at a single antenna comprises only analog components, this making the device simple and inexpensive and making it possible to limit excessive power consumption compared with other far-field detection solutions. Detection with a single antenna is simple and therefore inexpensive. The detection device according to an aspect of the invention makes it possible to reduce the intense transmission of microwaves and to respect the radio approval threshold in the communication band. The use of analog components also makes it possible to limit the processing to the evaluation of a voltage signal, this making it simple, efficient, reliable and fast, in particular compared with solutions using digital processing circuits. The simple oscillating-loop arrangement makes it possible to limit the size of the device to the size of a tag detector for near-field communication (NFC). The device according to an aspect of the invention may operate on its own by being coupled to an electronic control unit but the reduced size of the oscillating-loop arrangement also allows the device to be integrated into an existing BLE or UWB module, in particular to couple the detection antenna with the communication antenna of such a module. The device according to an aspect of the invention equally makes it possible to define a pre-detection strategy with a view to activating other functions such as for example the triggering, preferably automatic, of a communication via a communication module, in particular BLE or UWB, or activating a camera such as for example a dash cam or for access by facial authentication. The device according to an aspect of the invention is simple, inexpensive and consumes little power, this allowing power consumption to be optimized, in particular when the internal management system of the vehicle is in standby mode, for example when the vehicle is parked and locked. Since the impedance differences are proportional to the movement of the person, an aspect of the invention also makes it possible to detect the type of movement carried out by the person, in particular in order to trigger various functions of the vehicle.

Advantageously, the device is configured to attenuate the power of the detection antenna and/or the voltage signal of the source of the transistor to predetermined values in order to adjust the detection distance determined by the electronic control unit. It is thus possible to generate a detection bubble inside and/or outside the vehicle. Such a bubble may make it possible to perform several functions. For example, the bubble may be placed in the center of the vehicle and dimensioned (for example to a diameter of one meter) to detect an intrusion into the passenger compartment and trigger an intrusion alarm. For example again, the bubble may be dimensioned (for example to a diameter of ten meters) to detect a suspicious movement outside the vehicle in parking mode and activate a camera, for example a dash cam of the vehicle, in order to film the surroundings of the vehicle.

Preferably, the predetermined fixed frequency is greater than or equal to 2 GHz, preferably 2.45 GHz, for example between 2.45 GHz and 10.6 GHz, in order to use an approved frequency already used on existing smartphone-type equipment operating for example in 4G or in 5G or in Ultra-Wideband (UWB).

In one embodiment, the radiating impedance module comprises an attenuator installed between the detection antenna and the gate of the transistor, said attenuator being configured to attenuate the power of the detection antenna and/or the voltage signal of the source of the transistor.

In one embodiment, the radiating impedance module comprises a comparator configured to compare the output voltage of the source of the transistor with a predetermined voltage threshold corresponding to a detection distance. For example, a threshold of 10 mV may correspond to an area of 1 m, a threshold of 100 mV may correspond to an area of 5 m.

The resonant module may be integrated into the device or else be external to the device.

In one embodiment, the resonant module is a resonant antenna pattern and the coupling between the detection antenna and said resonant antenna pattern is electrical. For example, a resonant circuit placed opposite or beside the detection antenna makes it possible to adjust and optimize the operating frequency.

In another embodiment, the resonant module is a resonator and the coupling between the detection antenna and said resonator is magnetic. A resonator makes it possible to reduce the size of the antenna (radiating impedance) while maintaining detection performance. The resonator improves detection sensitivity.

In another embodiment, the resonant module is a communication antenna of the vehicle, external to the device, for example of Bluetooth® Low Energy (BLE) or Ultra-Wideband (UWB) type.

An aspect of the invention also relates to a motor vehicle comprising a detection device as presented above and an electronic control unit connected to the source of the transistor and configured to receive the voltage signal delivered by the source of the transistor and to detect a movement around the detection device when the value of the voltage of the source of the transistor is greater than a predetermined threshold.

Preferably, the electronic control unit is configured to detect a gesture on the basis of differences in the voltage value of the source of the transistor over a predetermined period of time.

In one embodiment, the vehicle comprises a communication antenna configured to be electromagnetically coupled to the detection antenna to form a resonator.

An aspect of the invention also relates to a method for detecting movement of a person by microwaves for a motor vehicle using the detection device as presented hereinabove, said method comprising the steps of:
transmission, by the detection antenna, of microwaves resonating at a predetermined fixed frequency,
reception of the microwaves reflected from said person,
detection, by the electronic control unit, of a movement of said person when the absolute value of the amplitude of the voltage signal measured at the source of the transistor differs beyond a predetermined amplitude threshold.

An aspect of the invention also relates to a computer program product, characterized in that it comprises a set of program code instructions which, when they are executed by one or more processors, configure the one or more processors to implement a method as presented hereinabove.

### BRIEF DESCRIPTION OF THE DRAWINGS

Other features and advantages of aspects of the invention will become more apparent on reading the following description. This description is purely illustrative and should be read with reference to the attached drawings, in which:

FIG. 1 schematically illustrates one embodiment of the vehicle according to the invention.

FIG. 2 schematically illustrates an assembly comprising a device according to an aspect of the invention powered by a voltage supply source and delivering a signal for detecting the movements of a person.

FIG. 3 schematically illustrates a first embodiment of the device according to the invention.

FIG. 4 schematically illustrates a second embodiment of the device according to the invention.

FIG. 5 schematically illustrates a third embodiment of the device according to the invention.

FIG. 6 schematically illustrates a fourth embodiment of the device according to the invention.

FIG. 7 schematically illustrates a fifth embodiment of the device according to the invention.

FIG. 8 schematically illustrates one embodiment of the method according to the invention.

FIG. 9 schematically illustrates an example of a voltage signal delivered at the output of the source as a function of time for a given movement.

### DETAILED DESCRIPTION OF EXEMPLARY EMBODIMENTS

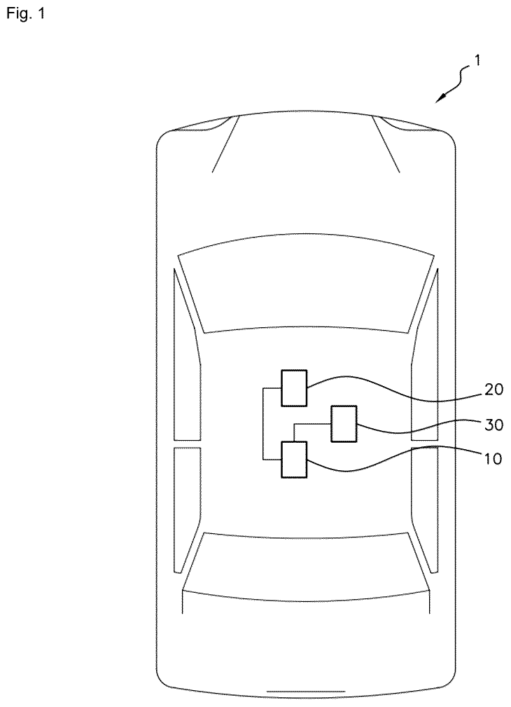

FIG. 1 schematically illustrates an example of a motor vehicle according to an aspect of the invention.

The vehicle 1 comprises a movement detection device 10 according to an aspect of the invention, an electronic control unit 20 and a DC voltage supply 30.

### Detection Device 10

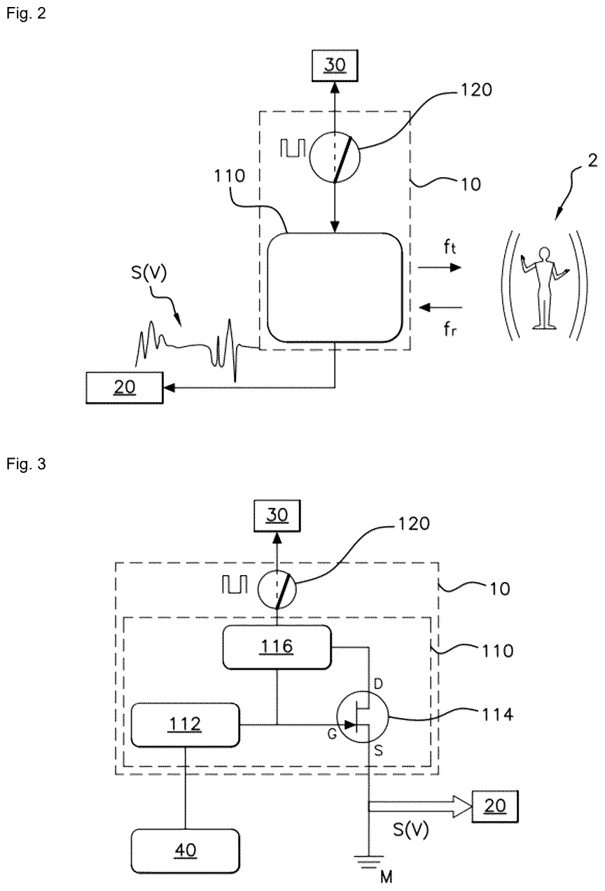

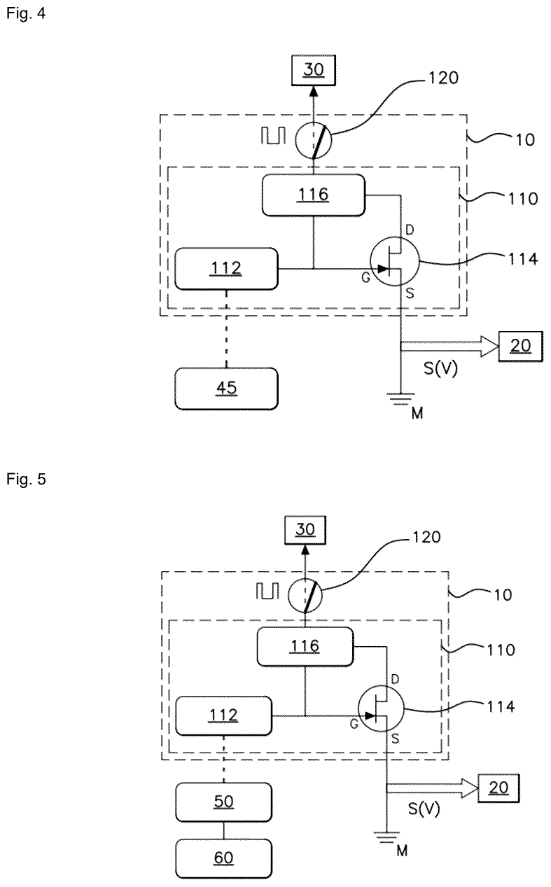

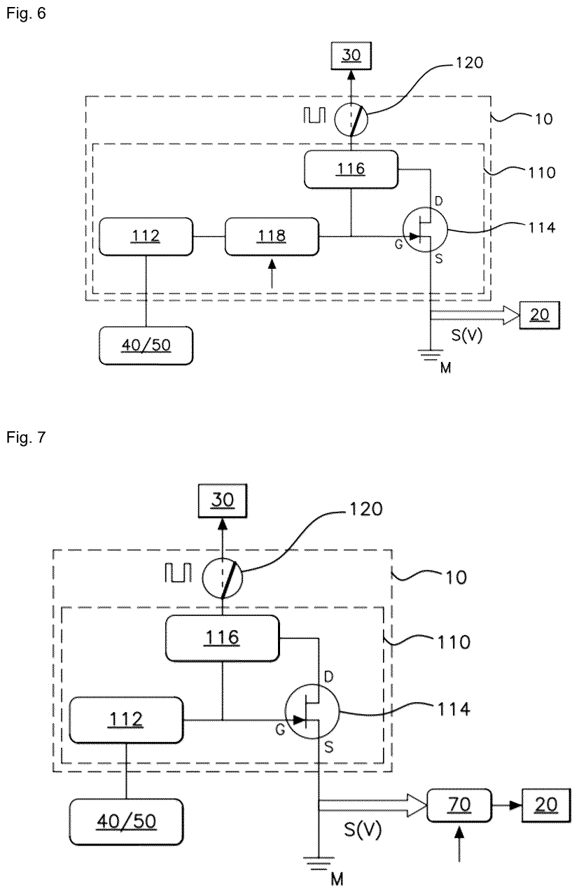

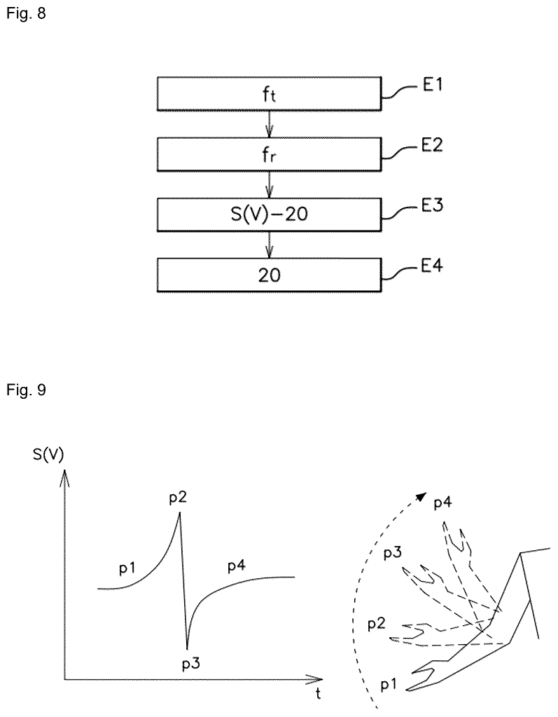

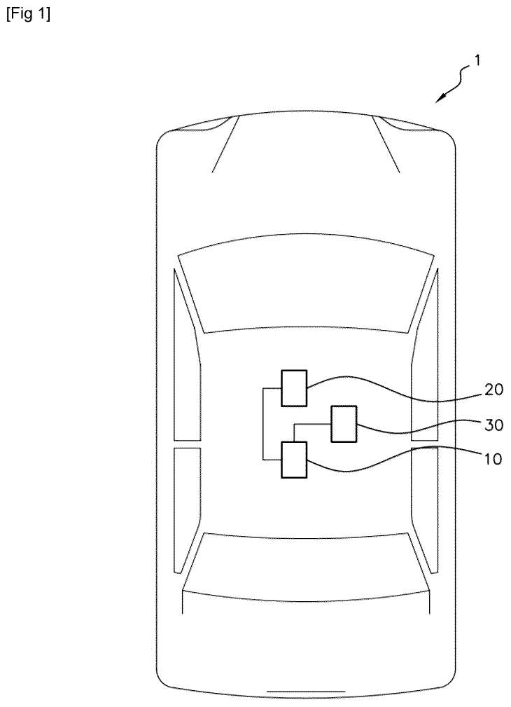

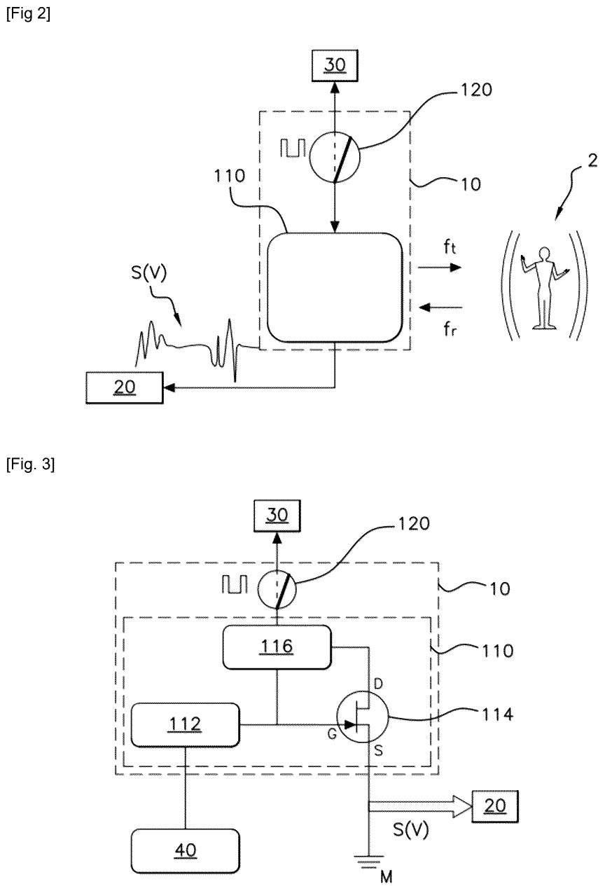

With reference to FIG. 2, the device 10 makes it possible to detect a movement of a person 2 by microwaves in order, for example, to unlock the opening elements of the vehicle 1 or to trigger communication, for example with the smartphone of the user of the vehicle 1. The device 10 may be installed at any location on the vehicle 1 but preferably at a communication module of the vehicle 1 or in the passenger compartment of the vehicle 1.

The device 10 comprises a radiating impedance module 110 configured to be powered by the DC voltage supply 30, for example 5 V.

The radiating impedance module 110 comprises a detection antenna 112, a MOSFET transistor 114 and an impedance matcher 116 forming an electrical loop.

The detection antenna 112 is configured to transmit microwaves ft by resonating at a predetermined fixed frequency and to receive microwaves fr reflected from a person 2 situated within the coverage of the transmitted microwaves ft, for example between 50 cm and 10 m from the detection antenna 112.

The transistor 114 is of the MOSFET type and comprises a gate G, a drain D and a source S.

The detection antenna 112 is connected to the gate G of the transistor 114.

The impedance matcher 116 is installed between the gate G and the drain D of the transistor 114 and is configured to match the impedance of the detection antenna 112 to the impedance of the transistor 114 while being powered by the voltage provided by the DC voltage supply 30.

The detection antenna 112, the transistor 114 and the impedance matcher 116 form a closed-loop electrical circuit oscillating at the predetermined fixed frequency when said circuit is powered by the voltage provided by the DC voltage supply 30.

The device 10 comprises a switch 120 connected between the radiating impedance module 110 and the DC voltage supply 30. This switch 120 is periodically controlled to open and close, for example at a refresh frequency of 10 Hz (every 100 ms), in order to only power the radiating impedance module 110 intermittently and thus limit the power consumption of the device 10. The switch 120 is controlled by the electronic control unit 20. The electronic control unit 20 sends a voltage to control the switch 120. For example, if the voltage is 5 volts, the circuit is closed and if the voltage is 0 volts, the circuit is open.

The source S of the transistor 114 is connected on the one hand to ground and on the other hand to the electronic control unit 20. The voltage signal S(V) delivered by the source S of the transistor 114 is received by the electronic control unit 20.

The electronic control unit 20 is configured to determine differences in the amplitude of the signal S(V) delivered by the source S of the transistor 114.

The signal S(V) delivered by the source S of the transistor 114 is a voltage signal representative of the impedance differences of the radiating impedance module 110.

The electronic control unit 20 is configured to determine whether the impedance of the radiating impedance module 110 is stable or different on the basis of the voltage measured at the source S of the transistor 114. More precisely, the electronic control unit 20 is configured to determine whether the voltage of the source S of the transistor 114 is stable (i.e. substantially constant) or different (i.e. differs beyond a threshold, in absolute value).

When the frequency of the microwaves fr reflected from the person 2 is equal to the frequency of the microwaves ft transmitted at the predetermined fixed frequency, indicating an absence of movement of the person 2, the voltage of the source S of the transistor 114 is substantially constant, that is to say that the impedance of the radiating impedance module 110 is stable.

On the other hand, when the frequency of the microwaves fr reflected from the person 2 differs by a frequency difference (in absolute value) of greater than a threshold, for example between 5 and 20 Hz, with respect to the predetermined fixed frequency, indicating the movement of a person 2 within the coverage of the detection antenna 110, the voltage of the source S of the transistor 114 differs beyond a threshold and the impedance of the radiating impedance module 110 is different.

The electronic control unit 20 comprises a processor able to implement a set of instructions for carrying out these functions.

### First Embodiment

In a first embodiment, illustrated in FIG. 3, the vehicle 1 or the device 10 comprises a resonant antenna pattern 40 and the detection antenna 112 is electrically coupled to said resonant antenna pattern 40 to resonate.

### Second Embodiment

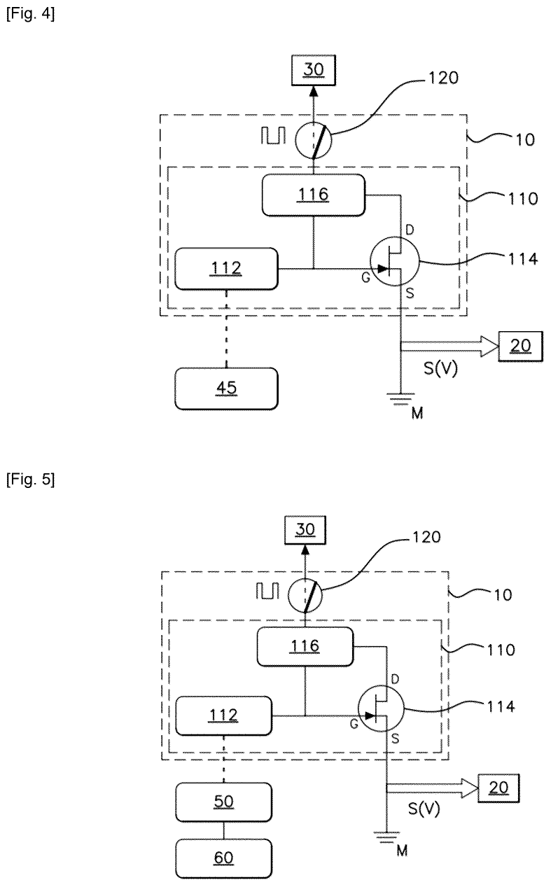

In a second embodiment, illustrated in FIG. 4, the vehicle 1 or the device 10 comprises a resonator 45 and the detection antenna 112 is magnetically coupled to said resonator 45 to resonate.

### Third Embodiment

In a third embodiment, illustrated in FIG. 5, the vehicle 1 comprises a communication antenna 50, for example of Bluetooth® Low Energy (BLE) or Ultra-Wideband (UWB) type, and the detection antenna 112 is electromagnetically coupled to said communication antenna 50 to resonate. The communication antenna 50 is connected to a communication module 60 to perform functions of the vehicle 1, in particular detecting the approach of a person 2 and communicating with the smartphone, a badge or a key for unlocking the vehicle 1 worn by the person 2, in a manner known per se.

### Fourth Embodiment

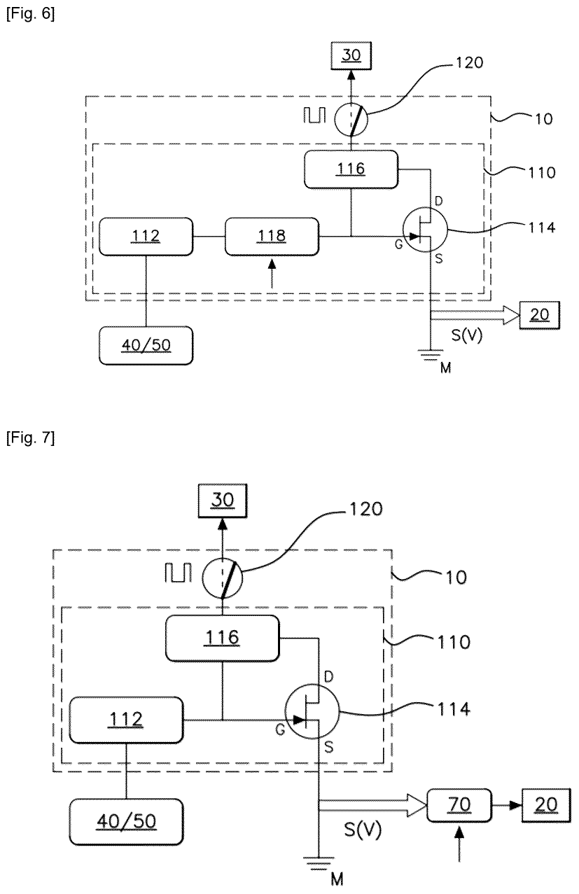

In a fourth embodiment, illustrated in FIG. 6, the radiating impedance module 110 comprises a radiofrequency attenuator 118 connected between the detection antenna 112 and the gate G of the transistor 114.

The radiofrequency attenuator 118 makes it possible to attenuate the signal received from the detection antenna 112 according to a predefined attenuation level which makes it possible to size the detection area.

### Fifth Embodiment

In a fifth embodiment, illustrated in FIG. 7, the vehicle 1 comprises a comparator 70 connected between the source S of the transistor 114 and the electronic control unit 20.

The comparator 70 compares the voltage signal provided by the source S of the transistor 114 with a predetermined voltage threshold corresponding to a predefined detection distance which makes it possible to size the detection area.

### Example of Implementation

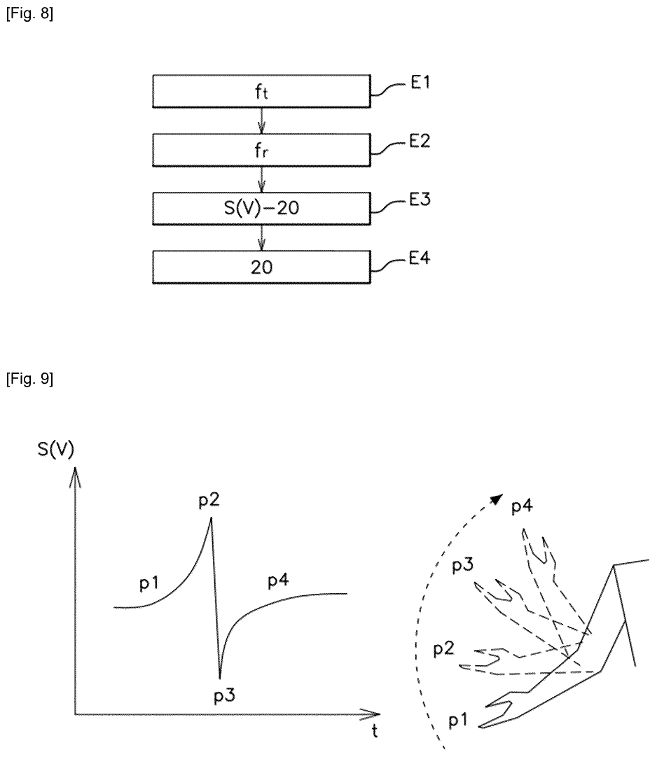

With reference to FIG. 8, in a step E1, the switch 120 is closed to power the electrical loop of the radiating impedance module 110 and the resonant module 40, 45, 50 causes the detection antenna 112 to resonate so that said detection antenna 112 transmits microwaves fₜ by resonating at the predetermined fixed frequency, for example 2.45 GHz.

In the presence of a person 2, the microwaves fₜ transmitted by the detection antenna 112 reflect from said person 2 and some of these reflected microwaves fᵣ return to the detection antenna 112 in a step E2.

In the absence of movement of the person 2 in the field of the detection antenna 112, the reflected microwaves fᵣ do not modify the impedance of the electrical loop of the radiating impedance module 110 which remains constant and so the voltage signal S(V) delivered at the output of the source S of the transistor 114 is zero.

When the person 2 makes a movement, the frequency of the reflected microwaves fᵣ differs (the signal reflected by a moving target undergoes a frequency shift, called the Doppler effect), this modifying the impedance of the electrical loop of the radiating impedance module 110 and producing a voltage signal S(V) delivered at the output of the source S of the transistor 114 the amplitude of which also differs.

In a step E3, the electronic control unit 20 detects said movement of said person 2 when the absolute value of the amplitude of the voltage signal S(V) measured at the source S of the transistor 114 differs beyond a predetermined amplitude threshold SAP.

Preferably, the electronic control unit 20 analyzes the differences in the amplitude of the voltage signal S(V) received and determines the gesture carried out by the person in a step E4.

FIG. 9 illustrates an example of a voltage signal S(V) as a function of time t for a movement carried out by the person 2. During the movement, P2, P3, respectively, show a positive frequency shift when the hand comes close to the detection antenna 112, and a negative shift when it moves away. P1 and P4 represent distant points where the signal is attenuated.

The invention makes it possible to detect the movements of a person 2 in a simple, inexpensive, fast and efficient manner by detecting the change in impedance of the radiating impedance module 110.

1. A device for detecting movement of a person by microwaves for a motor vehicle, said device comprising a radiating impedance module configured to be powered by a DC voltage supply via a switch, said radiating impedance module comprising a detection antenna configured to resonate at a predetermined fixed frequency when said detection antenna is coupled to a resonant module, to transmit microwaves and to receive microwaves reflected from said person, a MOSFET transistor and an impedance matcher forming a closed-loop electrical circuit oscillating at the predetermined fixed frequency when said circuit is powered by the voltage provided by said DC voltage supply, the detection antenna being connected to the gate of the transistor, the impedance matcher being installed between the gate and the drain of the transistor and being configured to match the impedance of the detection antenna to the impedance of the transistor while being powered by the voltage provided by said DC voltage supply, the source of the transistor being configured to be connected on the one hand to ground and on the other hand to an electronic control unit, the voltage signal delivered by the source of the transistor being representative of the impedance differences of the radiating impedance module, the impedance being stable when the frequency of the waves reflected from the person is equal to the frequency of the waves transmitted at the predetermined fixed frequency, indicating an absence of movement of the person, and different when the frequency of the waves reflected from the person differs by a frequency difference of greater than a threshold with respect to the predetermined fixed frequency, indicating the detection of a movement of the person.

2. The device as claimed in claim 1, wherein the predetermined fixed frequency is greater than or equal to 2.45 GHz.

3. The device as claimed in claim 1, wherein the radiating impedance module comprises an attenuator installed between the detection antenna and the gate of the transistor, said attenuator being configured to attenuate the power of the detection antenna and/or the voltage signal of the source of the transistor.

4. The device as claimed in claim 1, wherein the radiating impedance module comprises a comparator configured to compare the output voltage of the source of the transistor with a predetermined voltage threshold corresponding to a detection distance.

5. The device as claimed in claim 1, wherein the resonant module is a resonant antenna pattern and the coupling between the detection antenna and said resonant antenna pattern is electrical.

6. The device as claimed in claim 1, wherein the resonant module is a resonator and the coupling between the detection antenna and said resonator is magnetic.

7. The device as claimed in claim 1, wherein the resonant module is a communication antenna of the vehicle external to the device.

8. A motor vehicle comprising a detection device as claimed in claim 1 and an electronic control unit connected to the source of the transistor and configured to receive the voltage signal delivered by the source of the transistor and to detect a movement around the device when the value of the voltage of the source of the transistor is greater than a predetermined threshold.

9. The vehicle as claimed in claim 8, wherein the electronic control unit is configured to detect a gesture on the basis of differences in the voltage value of the source of the transistor over a predetermined period of time.

10. A method for detecting movement of a person by microwaves for a motor vehicle using the detection device as claimed in claim 1, said method comprising:
transmission, by the detection antenna, of microwaves resonating at a predetermined fixed frequency,
reception of the microwaves reflected from said person, and
detection, by the electronic control unit, of a movement of said person when the absolute value of the amplitude of the voltage signal measured at the source of the transistor differs beyond a predetermined amplitude threshold,
the source of the transistor differs beyond a predetermined amplitude threshold.

11. The device as claimed in claim 7, wherein the communication antenna of the vehicle is a BLE type or a UWB type.

12. The device as claimed in claim 2, wherein the radiating impedance module comprises an attenuator installed between the detection antenna and the gate of the transistor, said attenuator being configured to attenuate the power of the detection antenna and/or the voltage signal of the source of the transistor.
